(19) United States
(12) Patent Application Publication
(10) Pub. No.: US 2016/0214008 A1
(43) Pub. Date: Jul. 28, 2016

(54) INTEGRATED LOCAL SPORTS LEAGUE TRACKING AND SCORING PLATFORM

(71) Applicant: The Local Athlete, LLC, Dover, DE (US)

(72) Inventor: JOSEPH HECK, Middleton, WI (US)

(21) Appl. No.: 15/005,607

(22) Filed: Jan. 25, 2016

Related U.S. Application Data
(60) Provisional application No. 62/107,070, filed on Jan. 23, 2015.

(51) Int. Cl. A63F 13/352; A63F 13/235; A63F 13/46; A63F 13/537; A63F 13/79; A63F 13/215; A63F 13/828; A63F 13/2145

(52) U.S. Cl. CPC A63F 13/352; A63F 13/828; A63F 13/235; A63F 13/2145; A63F 13/537; A63F 13/79; A63F 13/215; A63F 13/46

(57) ABSTRACT

An integrated local sports league tracking and scoring system includes a local sports management server. The server includes a league management component executable on the local sports management server, the league management component managing payment, scheduling, and team registration operations for one or more local sports leagues. The server further includes a player management component executable on the local sports management server, the player management component managing a plurality of players associated with the one or more local sports leagues. The server includes a scoring component executable at least in part on the local sports management server, the scoring component configured to receive realtime data regarding scoring of a game occurring in the one or more local sports leagues, the scoring component including a user interface displayable on a remote system.

### CROSS-REFERENCE TO RELATED APPLICATIONS

The present application claims priority from U.S. Provisional Patent Application No. 62/107,070, filed on Jan. 23, 2015, the disclosure of which is hereby incorporated by reference in its entirety.

### TECHNICAL FIELD

The present disclosure relates to a management system for local sports leagues. In particular, the present disclosure relates to an integrated local sports league tracking and scoring platform.

### BACKGROUND

Local sports leagues, such as amateur team sports leagues (e.g., football, hockey, kickball, softball, basketball, etc.) are typically loosely arranged organizations operated using a very limited budget. As such, in such leagues, each team may be sponsored by a different local business, and the league itself may have limited access to robust scoring, recordkeeping, or other organizational systems. As such, although existing professional leagues utilize detailed systems that rely in either many users or cameras to capture plays, events, etc. to reliably capture scoring and other statistical information for each game, local sports leagues continue to rely on volunteers and paper scoring methods. This is particularly the case because the granularity and detail at which scoring tools for professional leagues are presented (and required, given the cost and investment implied in such systems), non-expert, inexperienced scoring volunteers would not be able to use such tools. As such, there is an absence of scoring and management tools suited to use in local sports leagues.

### SUMMARY

In summary, the present disclosure relates to a management system for local sports leagues. In particular, the present disclosure relates to an integrated local sports league tracking and scoring platform.

In a first aspect, an integrated local sports league tracking and scoring system includes a local sports management server. The server includes a league management component executable on the local sports management server, the league management component managing payment, scheduling, and team registration operations for one or more local sports leagues. The server further includes a player management component executable on the local sports management server, the player management component managing a plurality of players associated with the one or more local sports leagues. The server includes a scoring component executable at least in part on the local sports management server, the scoring component configured to receive realtime data regarding scoring of a game occurring in the one or more local sports leagues, the scoring component including a user interface displayable on a remote system.

In a second aspect, a method of tracking scoring in a local sports league application is disclosed. The method includes presenting a user interface on a touchscreen mobile device, the user interface including a depiction a game played as part of a local sports league, the user interface including a plurality of selectable scoring regions, each of the plurality of selectable scoring regions corresponding to a different scoring event that may occur during the game. The method further includes receiving a touch input from a user, on the user interface at one of the plurality of selectable scoring regions. The method also includes, upon receiving the touch input, registering a scoring event associated with the scoring region at which the touch input is received, and transmitting the scoring event to a local sports management server.

In other aspects, a mobile application useable to interface to the server can be provided. Various user roles can be provided, with each user having different access rights to data on the server.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The Figures illustrate various aspects of the invention, and are attached to this written description.

FIG. 1 is a schematic illustration of an example environment in which aspects of the sports league tracking systems and methods of the present disclosure can be implemented;

FIG. 2A is a schematic illustration of a computing system on which a scoring application according to aspects of the present disclosure can be implemented;

FIG. 2B is a schematic illustration of a computing system on which a local athletic competition tracking application according to aspects of the present disclosure can be implemented;

FIG. 3 is a logical diagram of sports supported by the integrated local sports league tracking and scoring platform of the present disclosure;

FIG. 4 is a logical diagram of regional options implemented within the integrated local sports league tracking and scoring platform of the present disclosure;

FIG. 5 is a schematic depiction of an example home page of a user interface for the integrated local sports league tracking and scoring platform of the present disclosure;

FIG. 6 is a schematic depiction of an example home page of a user interface for the integrated local sports league tracking and scoring platform of the present disclosure, according to a second possible embodiment;

FIG. 7 is a schematic depiction of an example signup page of a user interface for the integrated local sports league tracking and scoring platform of the present disclosure;

FIG. 8 is a schematic depiction of an example login page of a user interface for the integrated local sports league tracking and scoring platform of the present disclosure;

FIG. 9 is a schematic depiction of an example signup entry form page of a user interface for the integrated local sports league tracking and scoring platform of the present disclosure;

FIG. 10 is a schematic depiction of an example roster sign-up page of a user interface for the integrated local sports league tracking and scoring platform of the present disclosure;

FIG. 11 is a schematic depiction of an example team and player payment of a user interface for the integrated local sports league tracking and scoring platform of the present disclosure;

FIG. 12 is a schematic depiction of an example roster management page of a user interface for the integrated local sports league tracking and scoring platform of the present disclosure;

FIG. 13 is a schematic depiction of an example invitee message generated by the integrated local sports league tracking and scoring platform of the present disclosure;

FIG. 14 is a schematic depiction of an example matchup page of a user interface for the integrated local sports league tracking and scoring platform of the present disclosure;

FIG. 15 is a schematic depiction of an example statistics user interface for the integrated local sports league tracking and scoring platform of the present disclosure;

FIG. 16 is a schematic depiction of an example player tracking user interface for the integrated local sports league tracking and scoring platform of the present disclosure;

FIG. 17 is a schematic depiction of an example scoring home screen for the integrated local sports league tracking and scoring platform of the present disclosure;

FIG. 18 is a schematic depiction of an example basketball game scoring screen for the integrated local sports league tracking and scoring platform of the present disclosure;

FIG. 19 is a schematic depiction of an example basketball game scoring recap screen for the integrated local sports league tracking and scoring platform of the present disclosure;

FIG. 20 is a schematic depiction of a second example basketball game scoring screen for the integrated local sports league tracking and scoring platform of the present disclosure;

FIG. 21 is a schematic depiction of a third example basketball game scoring screen for the integrated local sports league tracking and scoring platform of the present disclosure;

FIG. 22 is a schematic depiction of a fourth example basketball game scoring screen for the integrated local sports league tracking and scoring platform of the present disclosure;

FIG. 23 is a schematic depiction of a gamestream page viewable by third parties for the integrated local sports league tracking and scoring platform of the present disclosure;

FIG. 24 is a schematic depiction of a statistical screen for the integrated local sports league tracking and scoring platform of the present disclosure; and

FIG. 25 is a schematic depiction of a mechanism for synchronizing player profiles with video game system player profiles, according to an example aspect of the present disclosure.

### DETAILED DESCRIPTION

As briefly described above, embodiments of the present disclosure are directed to an integrated local athletic competition tracking and sports league scoring platform. The platform is useable to aggregate statistics regarding recreational sports events, including competitions and practice tracking, using internet and cloud-based data storage. The majority of amateur leagues, both youth and adult, do not have a website. In addition to a lack of technological resources, league fees are still collected through personal checks. This creates inefficiencies. The integrated local sports league tracking and scoring platform of the present disclosure creates an online community through the use of blogs, connectivity to sites such as Facebook and YouTube, and other content. In addition, the platform will automate the collection of league dues and sign-up, creating a more efficient way for local leagues to manage their business. Furthermore, simplified scoring and realtime updates allow any amateur attendant at a game to accurately score such local sports league games, and aggregate that data in realtime for statistical tracking, aggregation, and management.

In example embodiments, the integrated local sports league tracking and scoring platform includes, among other features: aggregation of leagues by providing website services for leagues in various locations and for various sports; website administration and management; social networking; realtime updates of game statistics; blogs and message boards; league standings; payment management of league fees, individual or team submission/use; sponsor payments (for sponsored leagues), community support and local community-based placed advertising, organization for league commissioners to solicit past participant involvement; communications regarding cancellations or changes in venue; and coordinated team-based communications. This collection of features is not currently available in a manner that is tailored to local league management and administration, and use by untrained scoring personnel.

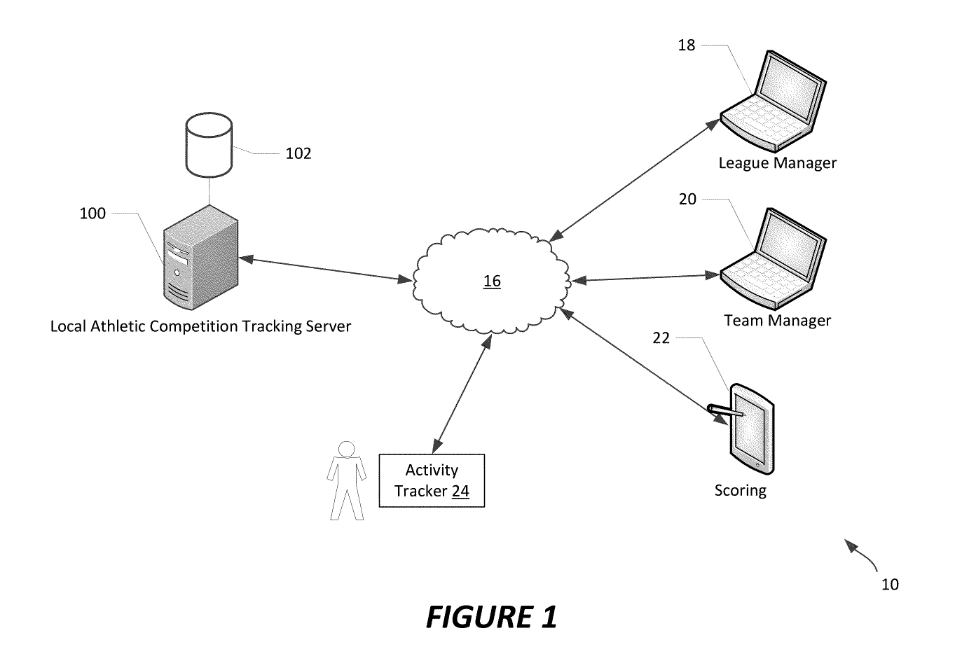

Referring now to FIG. 1, an example environment 10 is shown in which aspects of the present disclosure can be implemented. In particular, the example environment can be used to implement sports league tracking systems and methods of the present disclosure, including local sports leagues.

In the example embodiment shown, the environment 10 includes an integrated local sports league tracking and scoring platform, implemented on a local team scoring server 100. The local athletic competition tracking server 100 is connected to a database 102 that is configured to store team data, such as team rosters and team payments, contact information, league information and scheduling, etc., and scoring data, such as statistics captured during a game. The local athletic competition tracking server 100 is accessible to other computers via the interne 16, and various computing systems, and various types of users of such computing systems, can access data via the local athletic competition tracking server 100. As shown, this can include a league manager 18, a team manager 20, or a scorer 22. Additional entities or users of the system could include a player, a sponsor, an advertiser, or other entities having interest in the local sports league.

In example embodiments, the environment 10 can also include one or more activity trackers 24 associated with users of the local athletic competition tracking server 100, which can integrate activity tracking data in the database 102 to correlate user training with athletic competition performance. Such activity trackers can correspond to any of a variety of types of activity trackers available from Fitbit, Garmin, Jawbone, Google, Microsoft, and others. Details regarding such features are provided in greater detail below.

In the example shown, each of the users or entities may be afforded different access rights or presented with different user interfaces for managing tasks associated with the role of that user or entity. For example, a league manager may have rights to contact all participants in a league or manage teams in the league, while a team manager may have rights to manage a roster for a particular team, contact that team's members, manage team fees, or other communications. A scorer may have access to a particular scoring user interface, examples of which are disclosed herein. Team players may have access rights to make payments, view schedules, view statistics, edit contact information, or other similar rights. A sponsor may have rights to manage payments for a team or contact the team, while an advertiser may have rights to purchase advertisements in a particular local market or associated with a particular league for placement on a page of a web application or embedded within an application. Other entities may similarly be afforded different sets of rights.

Generally, the environment 10 can be implemented in a variety of different ways. Each of computing systems 18-20 associated with entities can be provided with an application, such as a mobile application, capable of scoring and tracking/managing team details. Alternatively, the application can be browser-based, such that each user need not install any software locally on a computing system. Furthermore, although a single computing system is shown for use as local athletic competition tracking server 100, it is recognized that other types and numbers of computing systems can be used, including hosted/cloud storage systems, distributed server systems, or other arrangements.

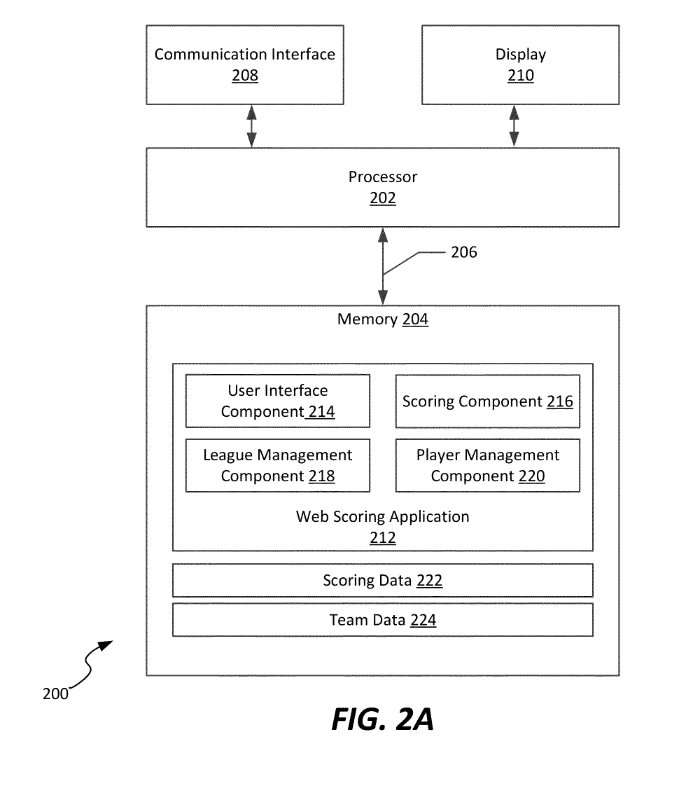

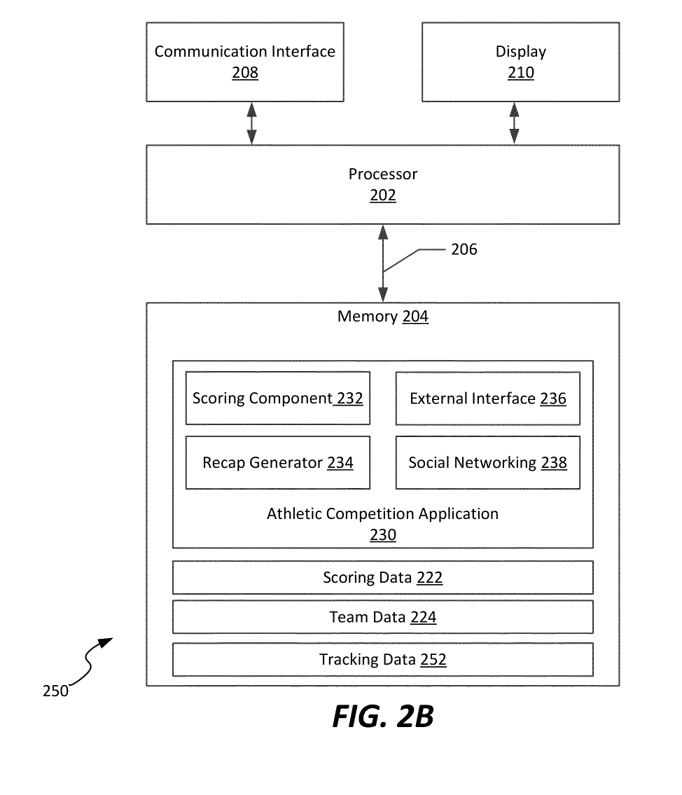

FIG. 2A is a schematic illustration of a computing system 200 on which a scoring application according to aspects of the present disclosure can be implemented. The computing system 200 can represent, for example, the local athletic competition tracking server 100 of FIG. 1, or can be implemented by some combination of the local athletic competition tracking server 100 and a remote system executing an application directed to remote data. In some embodiments, the computing system 200 represents a portable computing system, such as the league manager 18 or scorer 22, while a server that manages athletic competition tracking and management can be described as below in connection with FIG. 2B.

In general, the computing system 200 includes a processor 202 communicatively connected to a memory 204 via a data bus 206. The processor 202 can be any of a variety of types of programmable circuits capable of executing computer-readable instructions to perform various tasks, such as mathematical and communication tasks.

The memory 204 can include any of a variety of memory devices, such as using various types of computer-readable or computer storage media. A computer storage medium or computer-readable medium may be any medium that can contain or store the program for use by or in connection with the instruction execution system, apparatus, or device. By way of example, computer storage media may include dynamic random access memory (DRAM) or variants thereof, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Computer storage media generally includes at least one or more tangible media or devices. Computer storage media can, in some embodiments, include embodiments including entirely non-transitory components. In the embodiment shown, the memory 204 stores a local team scoring and management application 212, discussed in further detail below. The computing system 200 can also include a communication interface 208 configured to receive and transmit data, for example one or more data streams received from input modules 104 as seen in FIG. 1. Additionally, a display 210 can be used for presenting a graphical display of the local team scoring and management application 212, viewing reports associated with teams and scoring, or other information.

In various embodiments, the local team scoring and management application 212 includes a user interface component 214, a scoring component 216, a league management component 218, and a player management component 220. The computing system can also manage scoring data 222 and team data 224, for example in a database such as database 102 of FIG. 1.

In the example shown, the user interface component 214 generates user interfaces for display on a remote system, for example to present to a user team or scoring information. In example embodiments in which the remote system views local team data via a web application, the user interface component 214 can be maintained at the server 200; however, in alternative embodiments in which a local application resident at a remote system is used, the user interface component 214 may at least partially reside within such an application, and be distributed to a computing system when that application is installed.

Similarly, a scoring component 216 can be located at the server 200 or partially within an application, and presents a user interface allowing an untrained scorer to maintain statistics for a game occurring in a local sports league, as well as to manage realtime (or near-realtime) statistical updates of scoring data 222.

The league management component 218 allows league managers to manage different sports, leagues, sponsorships, scheduling, locations, logistics, and other features, while a player management component 220 allows team managers to manage team rosters, payments, and other features, while allowing players to view statistics, schedules, or other data associated with a team

The scoring data 222 can include any data captured by the scoring component 216, for example as may be entered using one or more of the user interfaces discussed herein. The scoring data 222 may vary based on the sport but generally corresponds to a set of typical statistical data for a sport; in the case of basketball, points, rebounds, assists, turnovers, fouls, etc. can be tracked, while in baseball, hits, at bats, runs, runs batted in, strikeouts, ERA, innings pitched, or other statistical measures could be used. Other sports could similarly have associated statistics, as is known in the art.

The team data 224 can include, in various embodiments, team data, such as a team name, location, schedule, players, payment management, and other maintenance information associated with the team. The team data 224 can be presented, for example using the user interface component 214 or scoring component 216, to present statistics regarding a particular team to a user of a computing system or remote application to access statistics or team data.

Referring now to FIG. 2B, a schematic illustration of a computing system 250 on which an athletic competition tracking application according to aspects of the present disclosure can be implemented. The computing system 250 represents a system hosting generalized athletic competition tracking, as well as local and amateur competition scoring as noted above.

Computing system 250 includes, in the embodiment shown, a processor 202 communicatively connected to a memory 204 via a data bus 206, as noted above in connection with computing system 200 of FIG. 2A. However, memory 204 in computing system 250 can store an athletic competition tracking application 230, which includes a scoring component 232, as well as a recap generator 234, an external interface 236, and a social networking component 238.

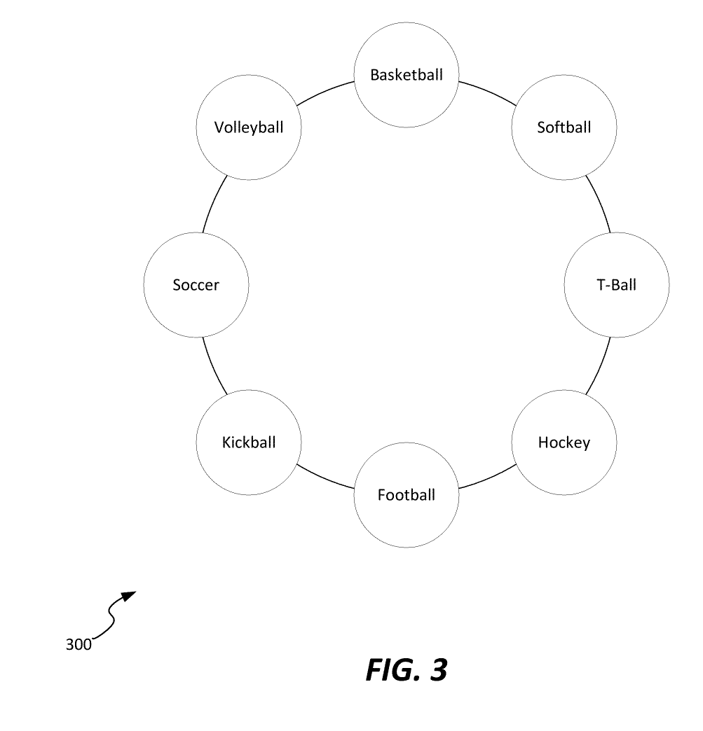

The scoring component 232 provides a server-side scoring tracking module useable in conjunction with a web-based or networked application installable on a mobile device and useable to track scoring of local competitions. The scoring component 232 can be used in conjunction with local team scoring and management application 212 described above in connection with FIG. 2A to provide convenient data aggregation and remote access to near-realtime local sporting competition statistics, for example by receiving in realtime the scoring events tracked in such a web-based or networked application. Details regarding such scoring are provided in further detail below in connection with FIGS. 3-25.

The recap generator 234 is configured to, based on an automated analysis of scoring events occurring during a local sports competition (e.g., on a game-by-game, or overall competition basis), generate one or more recap summaries associated with that game or competition. Such recaps can be made available by the computing system 250, alongside statistics associated with a particular game or competition, shortly following completion of that competition.

The external interface 236 provides data aggregated by the computing system 250, as well as receives data from external computing systems, and formats that data for storage in the computing system 250. The data provided to external systems can include, for example, training data, scoring data, and other performance information (generally corresponding to user profile information, generally) that can be exported to fitness tracking applications, external scoring applications, game applications (allowing integration of local players into game systems, as described below), and other systems in which such data may have relevance. Such user profile information can include, for example avatars or other personalization of a user profile such that the profile is readily exportable to gaming or other third party systems that are capable of receiving such avatar and user profile information.

In some embodiments, such external systems can include linked health insurance companies who may encourage users to be members of local sports leagues for purposes of encouraging activity among owners of a particular health insurance policy. Additionally, data integrated via the external interface 236 can include activity tracking information, or other manually (or offline) gathered statistical data. Such data can be formatted by the external interface 236 to match a storage form of the computing system 250, for example via integration of metadata-based APIs available from other third party data collections.

The social networking component 238 allows for communication and interaction among players, administrators, and other users by integrating league statistics, recaps, and other athlete tracking information with social networking platforms (e.g., Facebook, twitter, Instagram, etc.) that users may be members of, allowing for sharing of such tracked athletic data on those social networking platforms.

In the embodiment shown, the computing system 250 stores scoring data 222 and team data 224, but can also, in the embodiment shown store tracking data 252 as well. The tracking data 252 can be, for example, data directly received by the computing system 250 from a remote web interface associated with user performance, or could be activity tracker information received via the external interface 236.

FIG. 3 is a logical diagram 300 of sports supported by the integrated local sports league tracking and scoring platform of the present disclosure. As noted in the diagram 300, such local sports that can be tracked are not limited to basketball and softball, but could include junior sports such as t-ball, or could also include hockey, football, kickball, soccer, or volleyball. Of course, this listing of sports is not intended as limiting, but rather as a set of example sports with which the systems and methods of the present disclosure could be implemented.

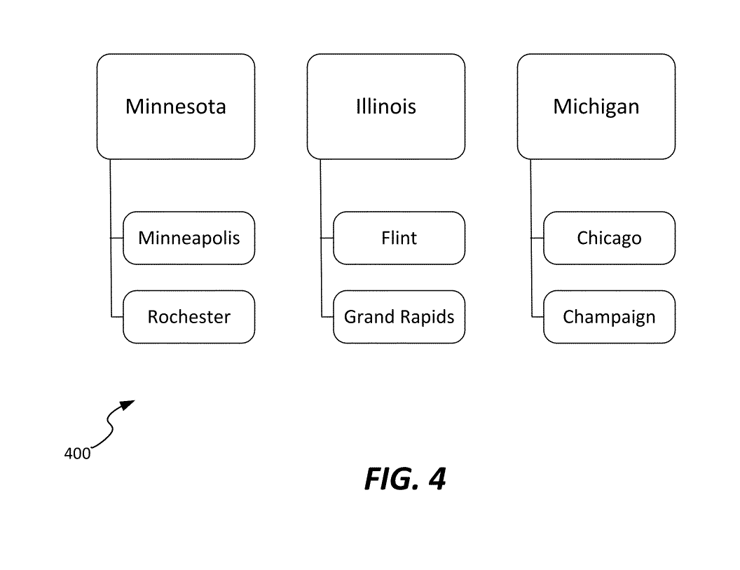

FIG. 4 is a logical diagram 400 of regional options implemented within the integrated local sports league tracking and scoring platform of the present disclosure. In the logical diagram 400, each of a plurality of regions is displayed, for example by state in which the platform is implemented. When each state is selected, local communities within which the platform is used can be displayed. Selection of one of the communities allows a user to view leagues that are active within that community, and to select a league for purposes of participation, viewing of statistics/schedules, or other analogous actions.

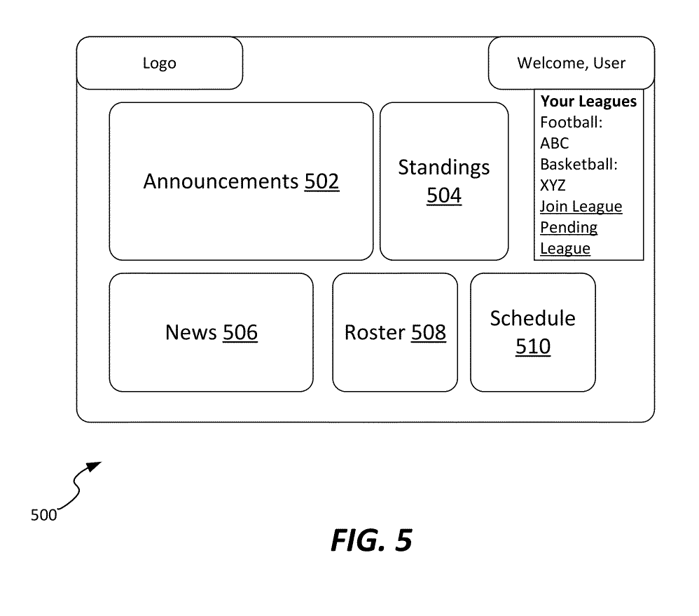

Referring now to FIGS. 5-16, user interfaces are displayed that can be used by a team manager or player to view details regarding a particular team or local sports league. In the embodiments illustrated, FIG. 5 is a schematic depiction of an example home page 500 of a user interface for the integrated local sports league tracking and scoring platform of the present disclosure. The home page 500 includes a plurality of regions, including an announcements region 502, a standings region 504, a news region 506, a roster region 508, and a schedule region 510. The home page 500 can also be branded with a particular logo, and can display to a logged-in user (based on a username and password or PIN-based login) the sports leagues and teams with which the user is associated.

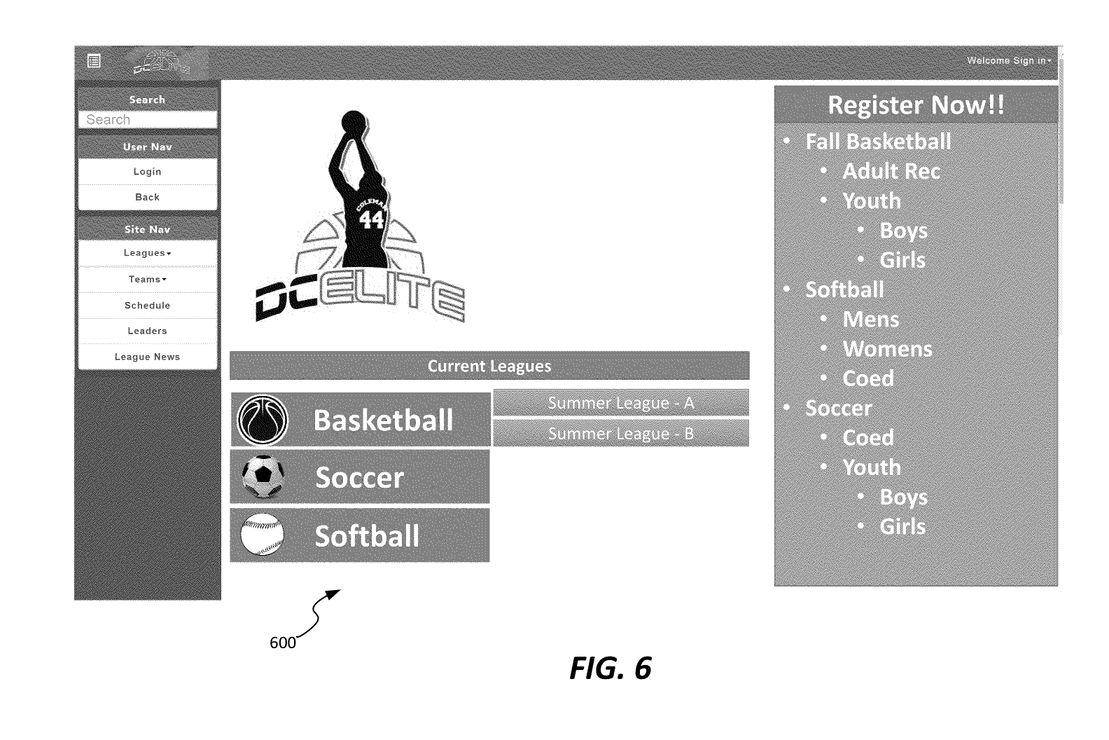

FIG. 6 is a schematic depiction of an example home page 600 of a user interface for the integrated local sports league tracking and scoring platform of the present disclosure, according to a second possible embodiment. The home page 600, compared to home page 500, is a home page for a particular user, and displays current leagues, as well as registration options for other leagues.

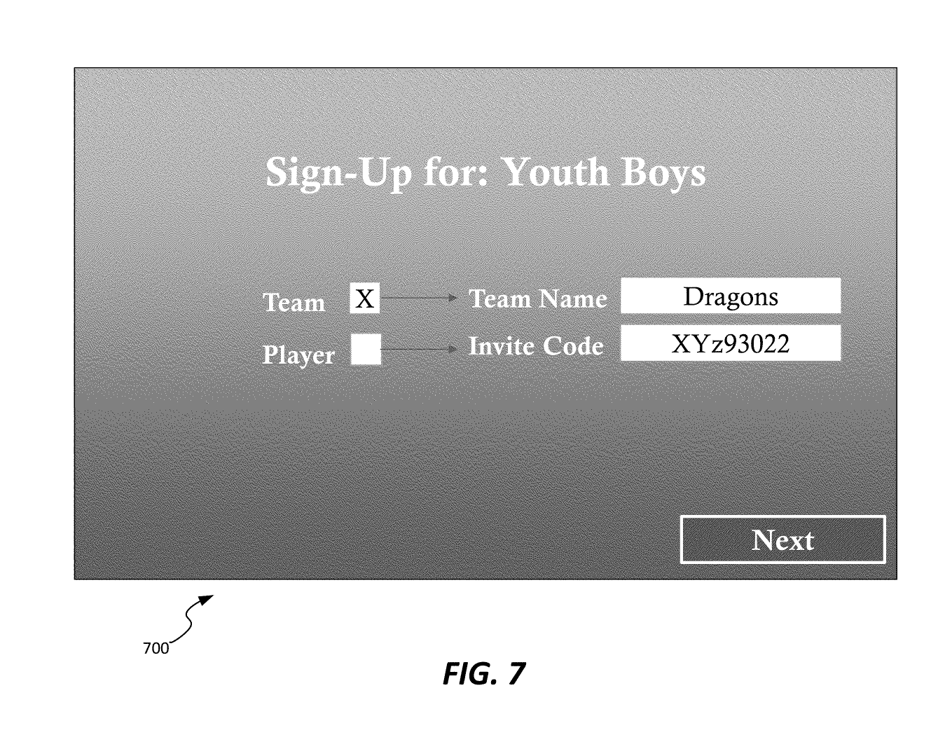

FIG. 7 is a schematic depiction of an example signup page 700 of a user interface for the integrated local sports league tracking and scoring platform of the present disclosure. The example signup page allows a user to sign up a team or player, for example by entering a team or player name as well as an invitation code that allows the team or player to register for a particular league.

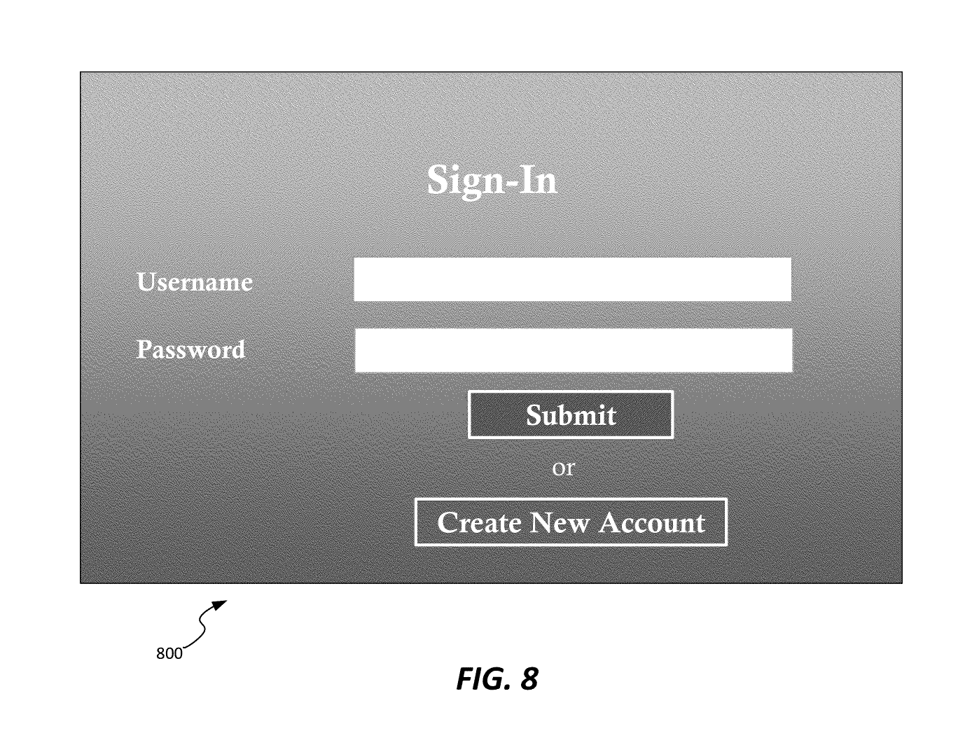

FIG. 8 is a schematic depiction of an example login page 800 of a user interface for the integrated local sports league tracking and scoring platform of the present disclosure. The login page 800 allows a particular user (e.g., a player or manager of a team) to log in to the system, as well as to select to create a new account for that individual.

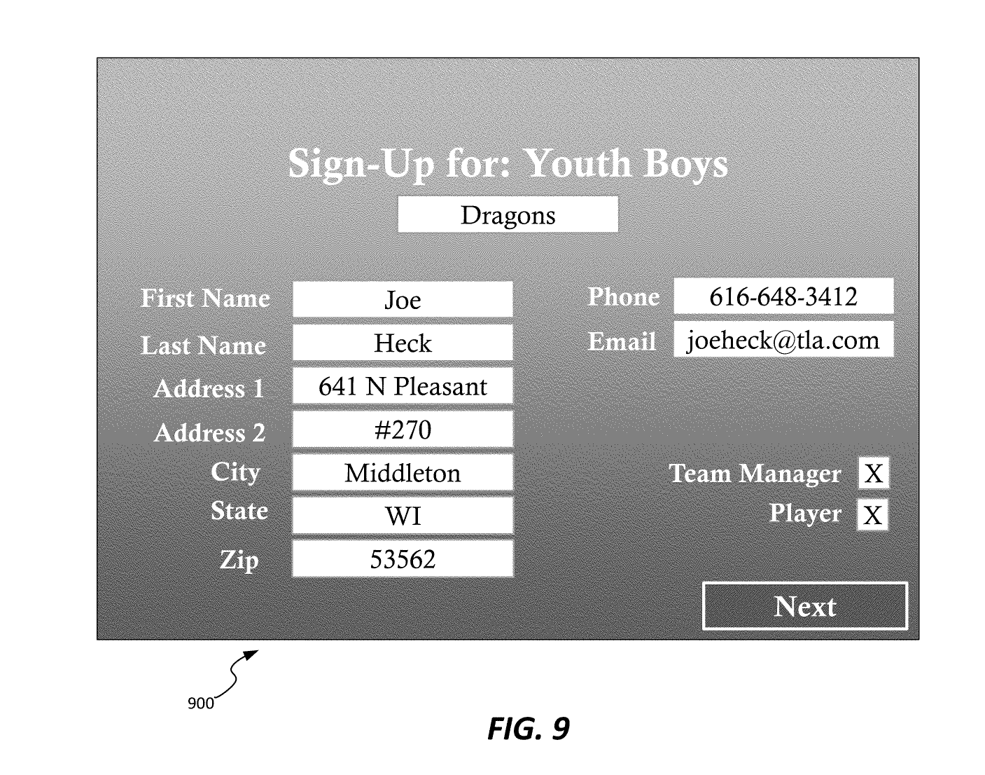

FIG. 9 is a schematic depiction of an example signup entry form page 900 of a user interface for the integrated local sports league tracking and scoring platform of the present disclosure. The signup entry form page 900, in the embodiment shown, includes an identification of a team on which the individual is a participant, and includes contact information for the individual, as well as selectable options for whether the individual is, for example, a team manager or player.

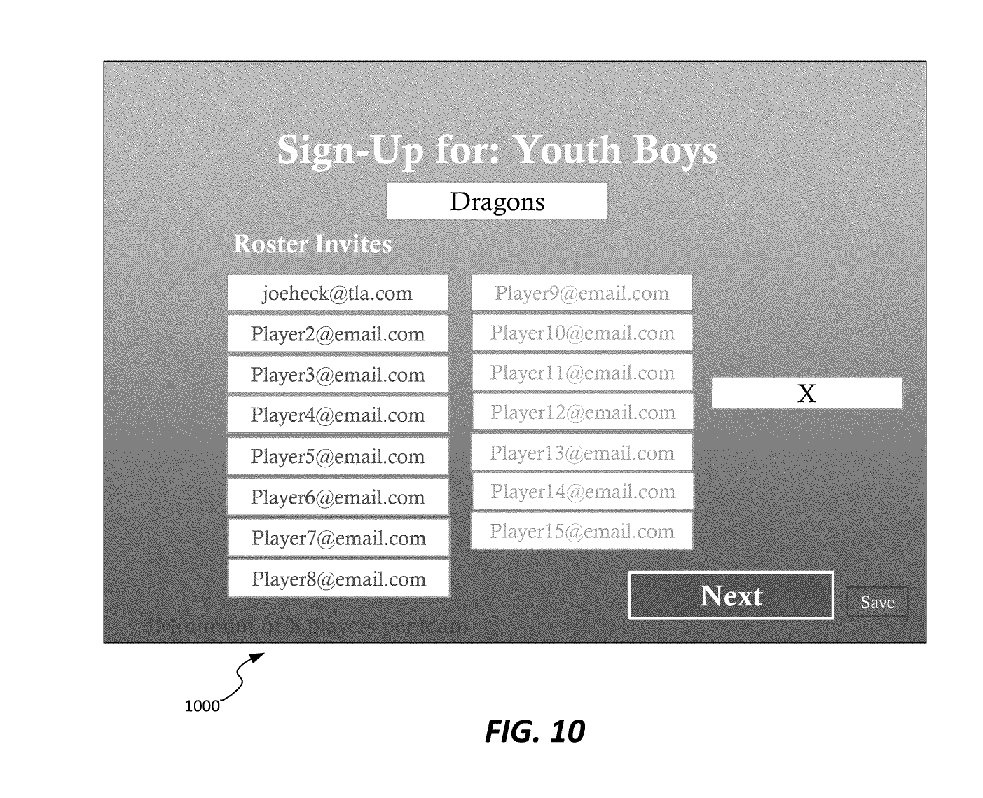

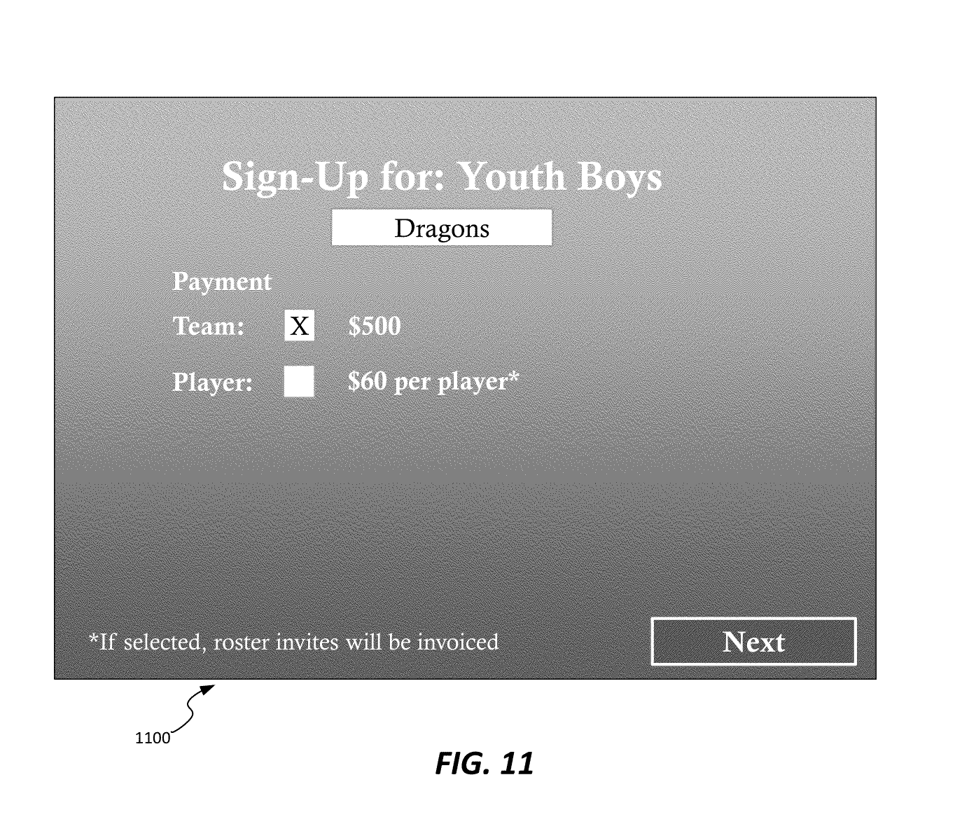

FIG. 10 is a schematic depiction of an example roster sign-up page 1000 of a user interface for the integrated local sports league tracking and scoring platform of the present disclosure. In the embodiment shown, the roster sign-up page 1000 includes roster invitee areas, thereby allowing a team manager to invite players to join a particular team. Relatedly, FIG. 11 is a schematic depiction of an example team and player payment page 1100 of a user interface for the integrated local sports league tracking and scoring platform of the present disclosure, on which the team manager may pay for a team entry fee, or a player may pay for that individual's fee. Such a page 1100 allows a user to view reminders regarding player or team fees that are due, manage/make payments, and other options.

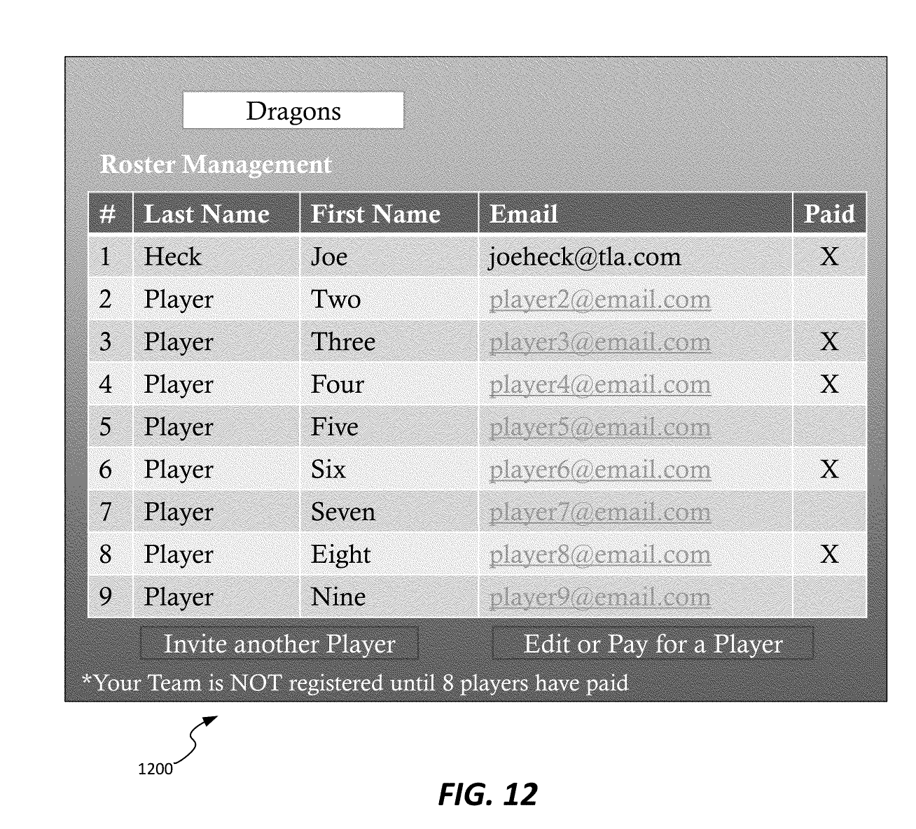

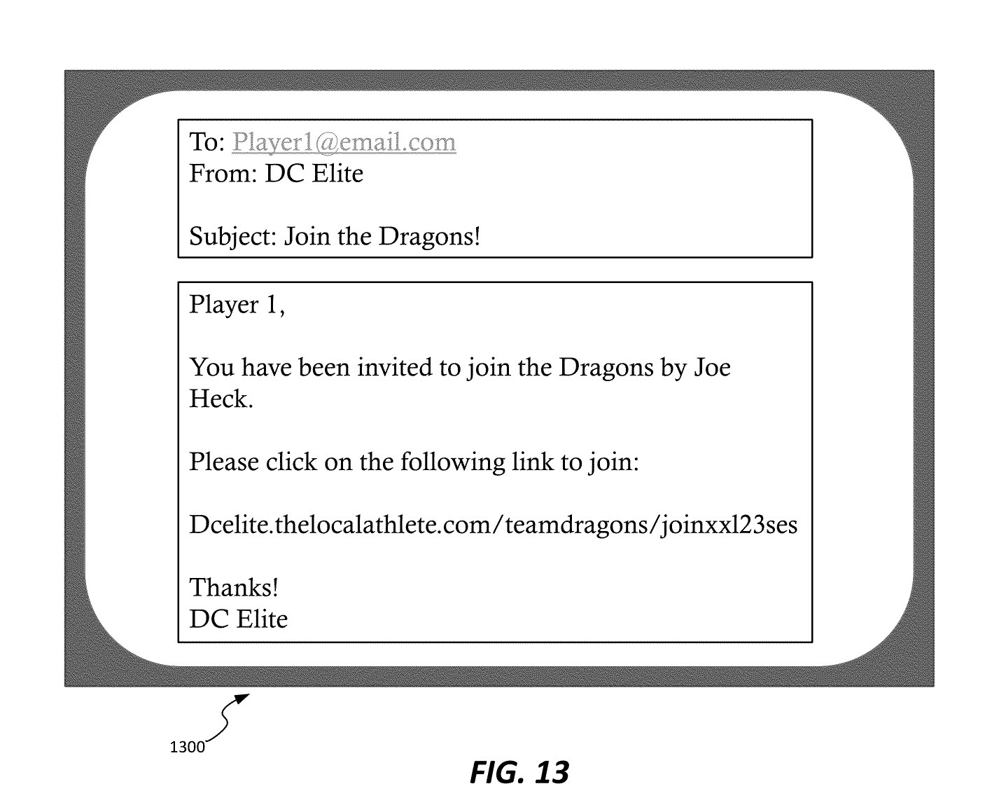

Additionally, FIG. 12 is a schematic depiction of an example roster management page 1200 of a user interface for the integrated local sports league tracking and scoring platform of the present disclosure; in the roster management page 1200 shown, a team manager can view his/her roster, contact information for the roster, as well as whether each player has paid his/her entry fee. FIG. 13 is a schematic depiction of an example invitee message 1300 generated by the integrated local sports league tracking and scoring platform of the present disclosure, in which each player can be sent a link that allows the player to reach a signup or payment page, such as in FIGS. 9-11, above.

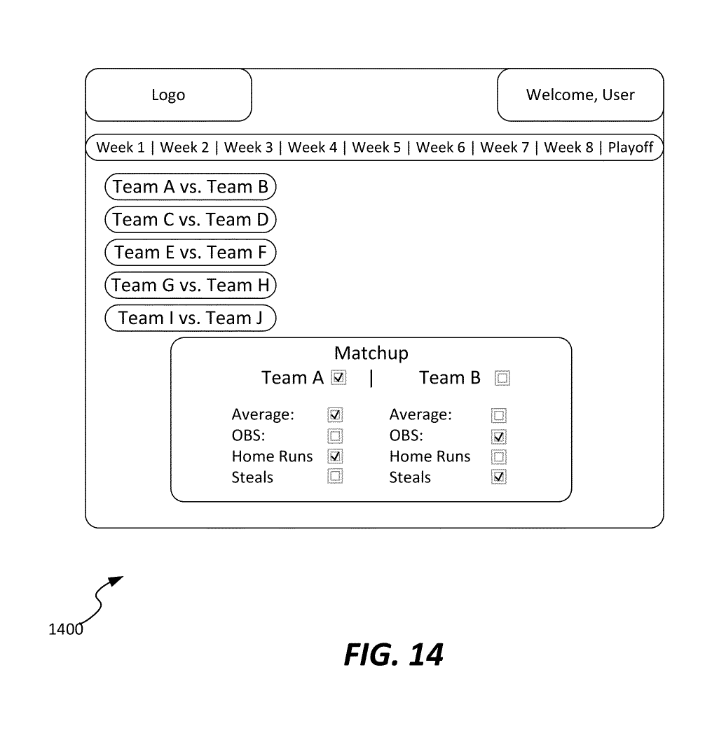

FIG. 14 is a schematic depiction of an example matchup page 1400 of a user interface for the integrated local sports league tracking and scoring platform of the present disclosure. The matchup page 1400 can be presented to a user, team manager, or league manager within the integrated local sports league tracking and scoring platform to display or establish team and season schedules. In the embodiment shown, the matchup page includes a breakdown of typical statistical categories to illustrate which team has statistical advantages regarding such typical categories. In the example shown, in which baseball or softball is the relevant sport, typical statistics such as batting average, OBS, home runs, and steals are displayed. Other statistics could be displayed as well. Additionally, the matchup page, as well as various other user interface screens, can be customized in various ways. For example, a user may customize jersey colors or numbers associated with a roster, for purposes of easier tracking relative to the current uniform appearance associated with a particular team.

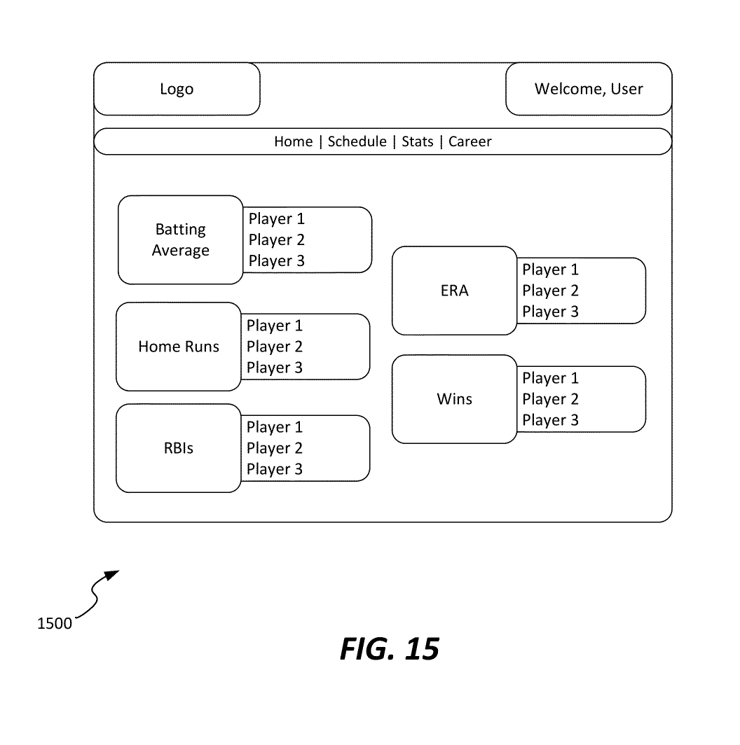

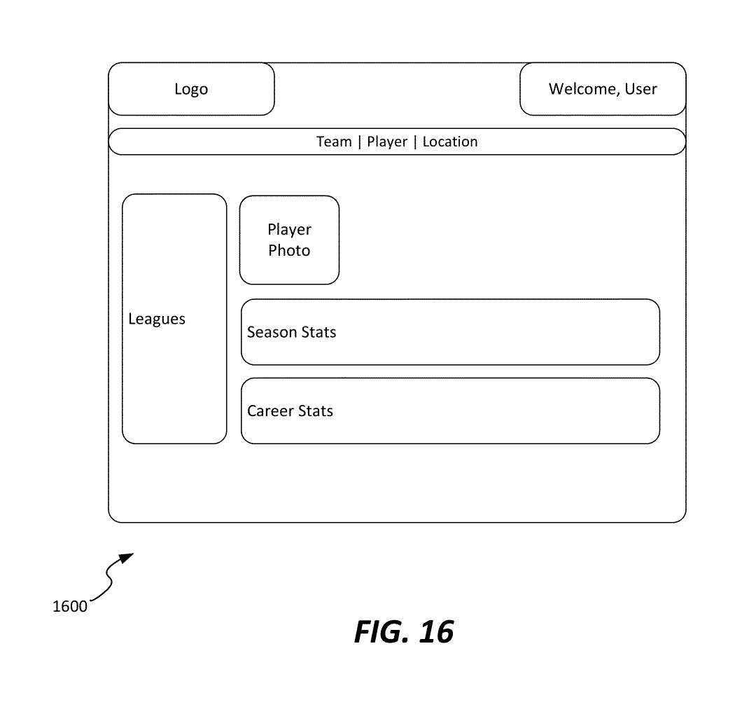

Various statistical displays can be provided as well, and can be navigated to from the home page 500. FIG. 15 is a schematic depiction of an example statistics screen 1500 of the user interface for the integrated local sports league tracking and scoring platform of the present disclosure. The statistics screen 1500 illustrates statistics for a particular team, organized by statistical category. Similarly, FIG. 16 is a schematic depiction of an example player tracking screen 1600 of the user interface for the integrated local sports league tracking and scoring platform. The player tracking screen 1600 displays player statistics and leagues in which the player is participating.

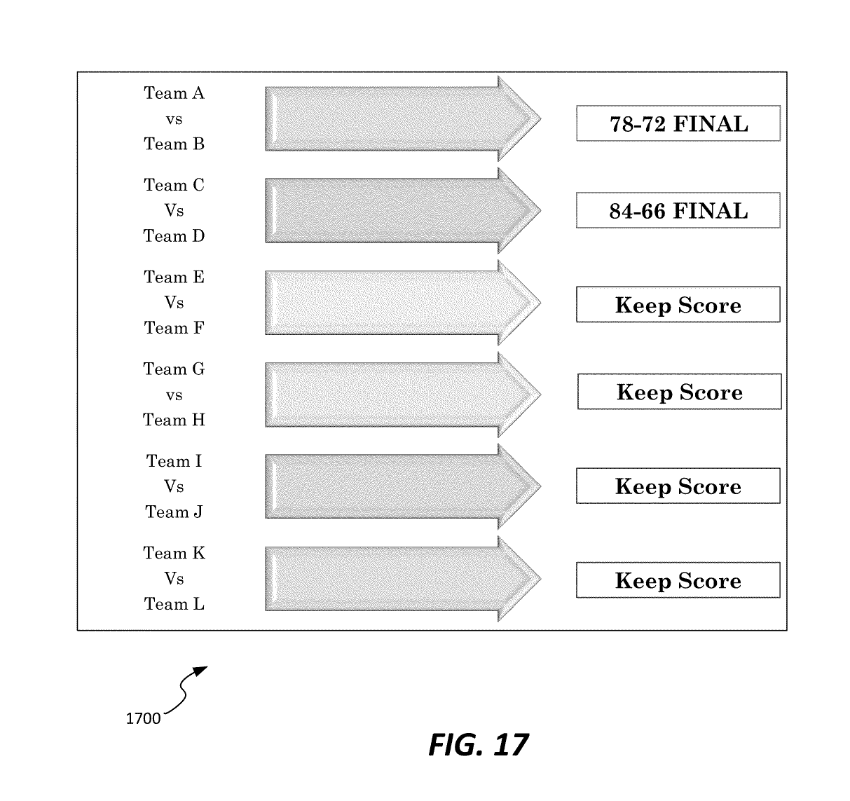

Referring now to FIGS. 17-21, additional user interfaces can be presented to users, for example based on operation of the scoring component 216 of FIG. 2. In particular, the user interfaces presented herein allow users to easily score games in local sports leagues, and provide such scoring data in at least near realtime. In the example shown, FIG. 17 is a schematic depiction of an example scoring home screen 1700 for the integrated local sports league tracking and scoring platform of the present disclosure. The scoring home screen 1700 displays each of the game matchups for a particular round of matchups (e.g., each week). Each matchup has an associated indicator to identify whether the matchup has occurred (in which case a final score is displayed) or a “Keep Score” indicator that can be selected to enter a scoring screen, such as those disclosed herein.

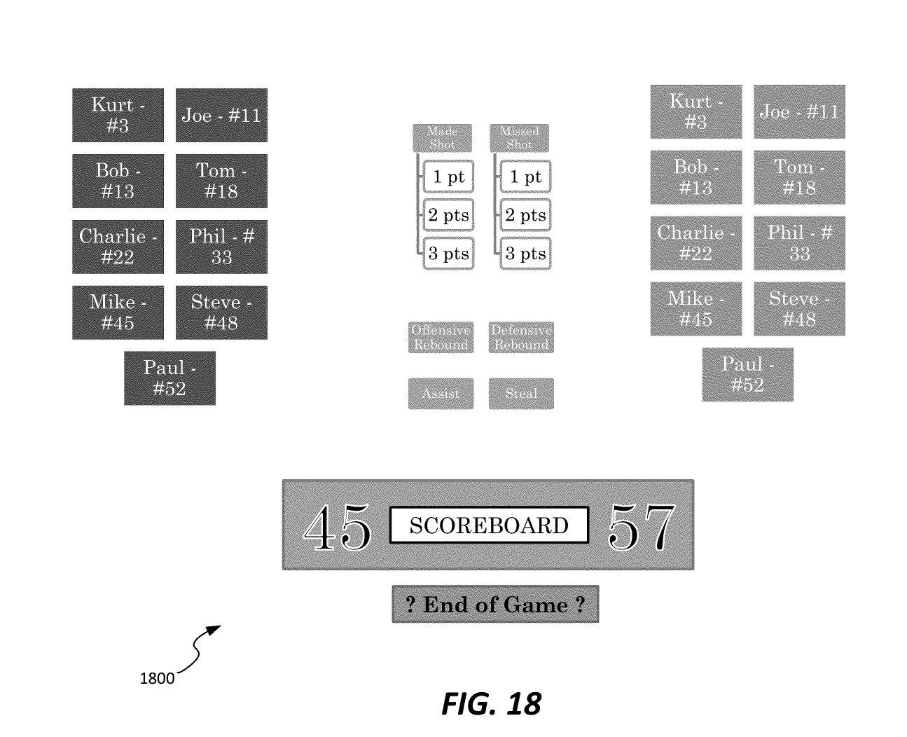

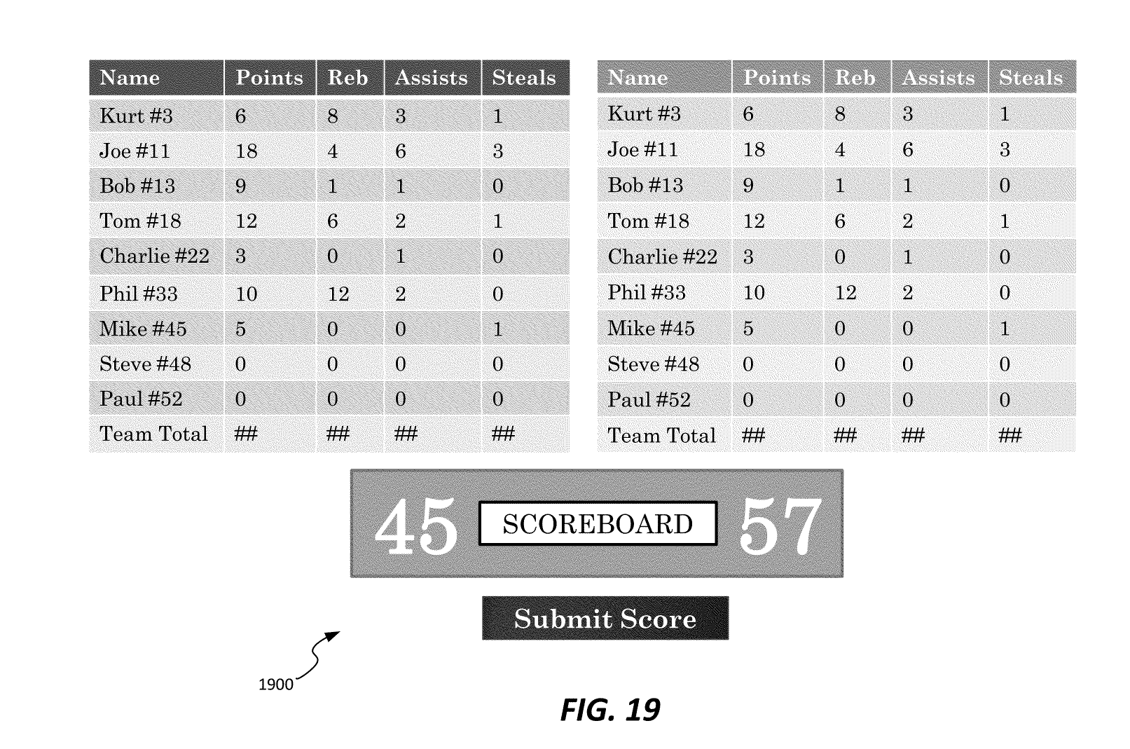

FIG. 18 is a schematic depiction of a first example basketball game scoring screen 1800 for the integrated local sports league tracking and scoring platform of the present disclosure. The basketball scoring screen 1800 is arranged to allow for ease of use, in that it can be displayed on a smartphone or tablet and can easily receive touchscreen input to identify changes in a score and accurately track scoring and player activity. In the embodiment shown, the basketball scoring screen 1800 includes a scoreboard, roster regions, and a central scoring region. To score a game, a user simply would select a player and then select the scoring activity that occurred. For example, if “Kurt—#3” scored a field goal, assisted by “Joe—#11”, the user could select the “Kurt—#3” button and then select the “2 pts” button to increase that team's score by 2, and then select the “Joe—#11” button and then the “assist” button to tally Joe's assist. Similarly, other plays, or combinations of statistical occurrences in a game, can readily be tracked. For example, a missed shot would be tracked the same way, but would not update the overall score, and would be tracked using the “miss” buttons. At the end of a game, the “End of Game” button below the scoreboard would be selected, which will report the final game data and update the scoring home screen 900 accordingly. Optionally, selecting the “End of Game” button would take the scoring user to a scoring recap screen to review the scoring prior to its submission, for example as illustrated in FIG. 19.

FIG. 19 is a schematic depiction of an example basketball game scoring recap screen 1900 for the integrated local sports league tracking and scoring platform of the present disclosure. The scoring recap screen 1900 displays an aggregated listing of scoring events in the game, in this case in the form of a box score. Upon approval of the scoring events, the user would select the “submit score” button to report the score to the server 100, thereby updating the scoring data 224 and accordingly update the scoring home screen 1700.

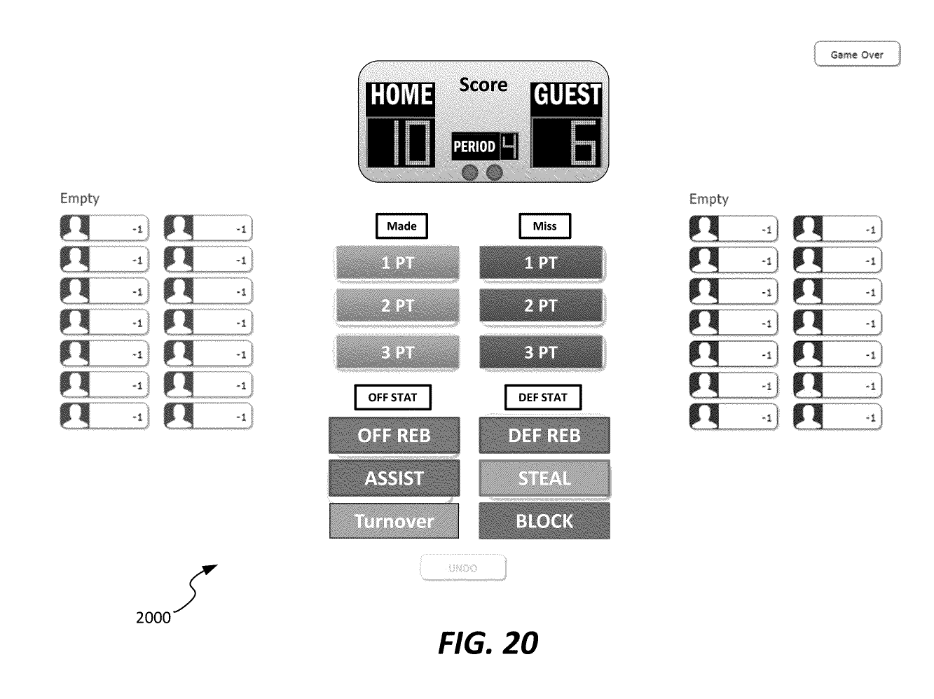

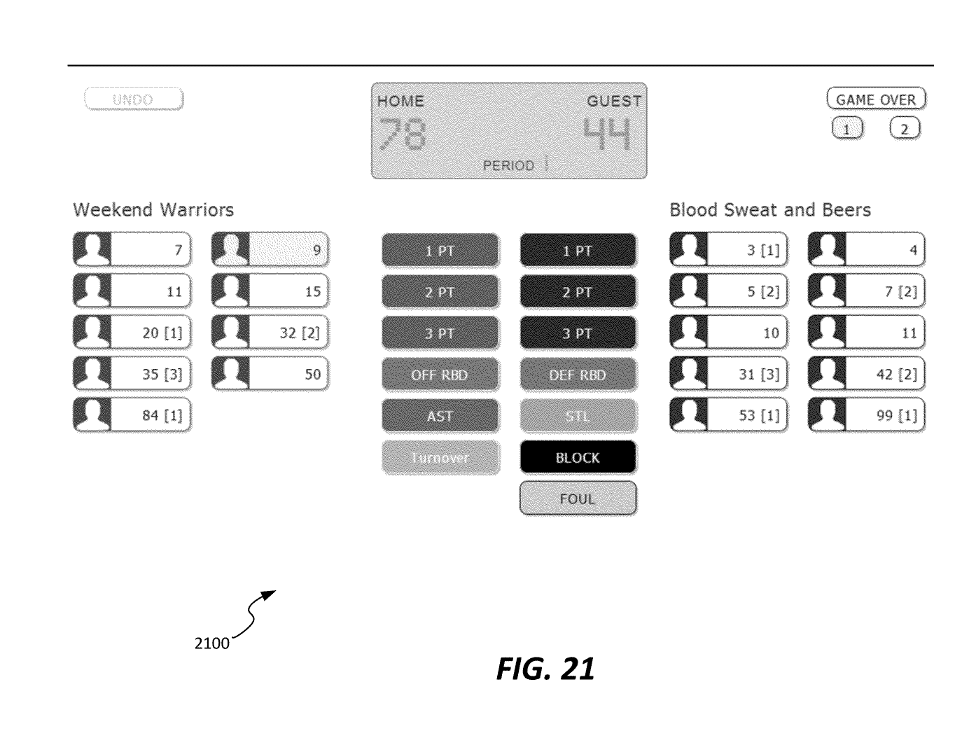

FIG. 20 is a schematic depiction of a second example basketball game scoring screen 2000 for the integrated local sports league tracking and scoring platform of the present disclosure. In this example screen, various alternative statistics can be tracked, for example steals, blocks, and turnovers. In a still further example screen 2100 shown in FIG. 21, other types of statistics could be tracked, such as blocks, fouls, or other features. In each of the example scoring screens, an “undo” feature allows a user to easily step backwards and undo particular scoring records where a mistake is made.

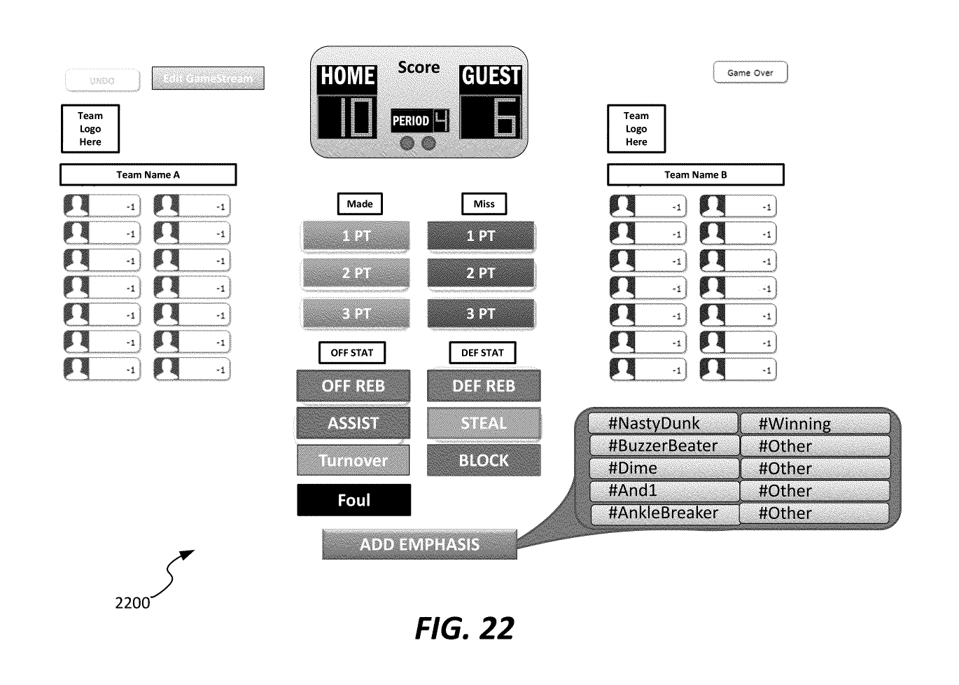

FIG. 22 is a schematic depiction of a second example basketball game scoring screen 2200 for the integrated local sports league tracking and scoring platform of the present disclosure. In this example screen, a further “Add emphasis” button allows an untrained scorer to add, within a game stream, one or more pieces of color commentary related to a play that recently occurred. For example, in the scoring screen 2200 as shown, upon selection of the “add emphasis” button, one or more additional tags may appear and be selectable, such as an indication of a dunk, assist, buzzer beater, or other type of notable play in the particular sport being scored.

It is noted that although in typical embodiments the scoring of a particular game may be performed by a touch input to one of the screens described above, other input mechanisms could be used as well. For example, in some cases, a scoring application may accept voice input from a scorekeeper, freeing the scorekeeper to talk into a Bluetooth or other microphone associated with a user device to record statistics. For example, a simple command, such as “Red 10, two points” or “Blue 22, foul” would allow the application to recognize a team, player, and action, and record a scoring event accordingly (assuming that the scoring system could recognize the scorekeeper's voice or otherwise filter out other voice input). This should allow for more accurate statistics by allowing the scorekeeper to keep his or her attention on the game rather than viewing the screen, as well as freeing up the touch screen device for other inputs, such as timekeeping.

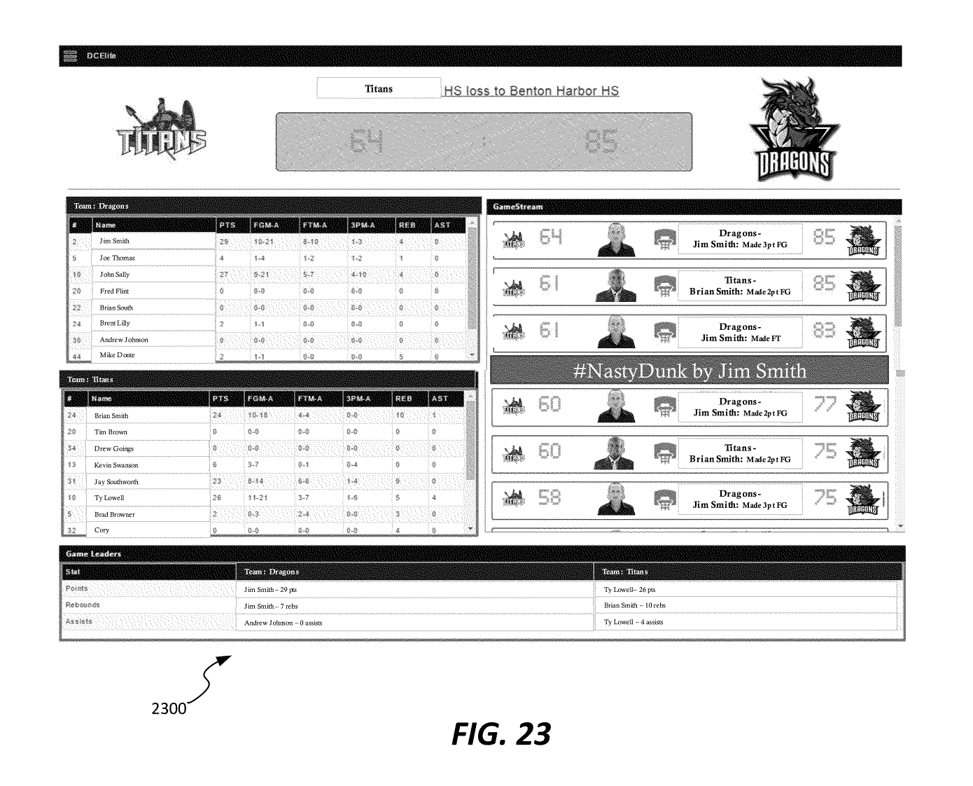

FIG. 23 is a schematic depiction of a gamestream page 2300 viewable by third parties for the integrated local sports league tracking and scoring platform of the present disclosure. The gamestream page 2300, in the embodiment shown, represents a realtime or near-realtime update of a game flow based on the scoring performed using any of the screens 2000-2200, described above. As noted in the gamestream page 2300, statistics are tracked, as well as a sequence of events and color commentary, as may be entered by a scorer using the game scoring screen 2200 of FIG. 22.

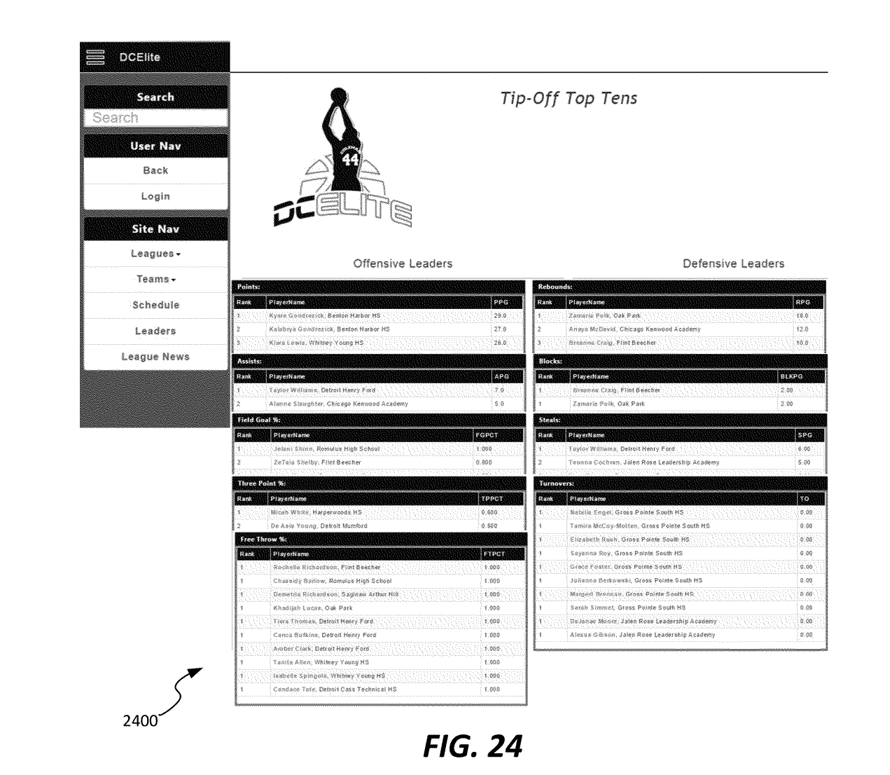

FIG. 24 is a schematic depiction of a statistical screen 2400 for the integrated local sports league tracking and scoring platform of the present disclosure. In the embodiment shown, the statistical screen 2400 can be updated, for example upon submission of a complete game scoring process, to the local athletic competition tracking server 100. The statistical screen can present leader statistics for a particular league in a variety of categories, as well as optionally regional leaders (e.g., state, nation, etc.) or team and game leaders as desired by a user of the application for purposes of viewing such statistics.

It is noted that in addition to the above, a variety of other types of user interfaces can be presented to assist in interaction among teams, players, and leagues. For example, each team may have a team message board, or there may be a message board associated with a particular game scoring page or leaderboard page.

In addition to the leaderboard and statistical pages, such features can be used to award players and/or teams, by awarding, for example, other league memberships, monetary prizes, sponsorships or other valuable system features to successful teams or individuals. Additionally, such success may be reflected in user profiles, for example by upgrading a user profile when that user profile is provided to a video game system as a player profile.

In addition, and as a further manner of input associated with the user interfaces of FIGS. 3-24, it is noted that at least during a scoring sequence during a game, in addition to the touch-screen user input functionality presented herein, other types of convenient scoring inputs could be provided as well. In some example embodiments, voice-recognition or voice-activated input could be provided. Continuing the scoring example discussed above, if “Kurt—#3” scored a field goal, assisted by “Joe—#11”, the user could simply state “Number three, two points, number eleven assist” which would increment that team's score (and the individual's scoring record) and tally Joe's assist. If player numbers are duplicated across teams, other inputs, such as “Home number three” (representing player #2 on the home team) to distinguish among player events. Other spoken word identification processes useable to uniquely identify scoring events in a manner useable by untrained scorers could be provided as well.

Furthermore, and relating to FIGS. 3-24, it is noted that the user interfaces depicted herein can be generated either within a networked application that is connected to an athlete competition tracking server 250, or web interface similarly connected, to allow for simplified tracking of athlete records. Furthermore, generally a single device will be designated as a scorekeeping device, such that other devices connected to an athlete competition tracking server 250 or server 200 can follow a game in near-realtime via an analogous user interface to those shown, but will not have the ability to edit or add to statistical tracking. Other arrangements are possible as well, consistent with the present disclosure.

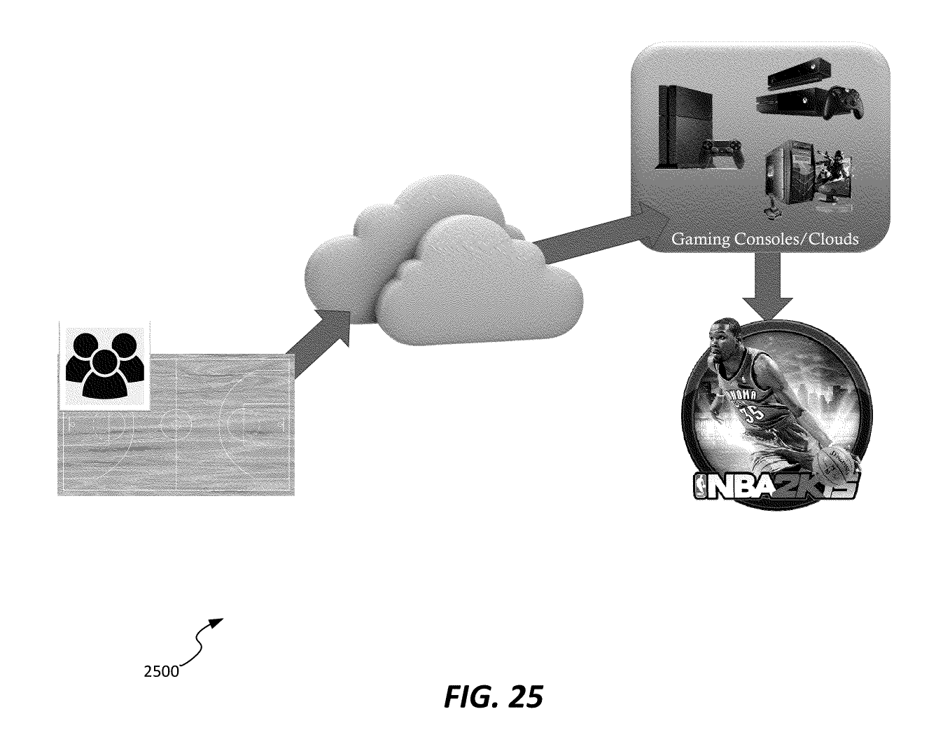

FIG. 25 is a schematic depiction of a mechanism for synchronizing player profiles with video game system player profiles, according to an example aspect of the present disclosure. In the embodiment shown, the mechanism includes receipt of scoring statistics, as well as player profiles (e.g., age, height, weight, etc.) that can be uploaded, via local athletic competition tracking server 100, to one or more game consoles or gaming arenas (in the case of cloud-based gaming). The game upload may be according to one or more APIs available for a particular sport-based video game. Such player profiles can be converted to avatars in a particular sports-based video game (e.g., basketball in the embodiment shown), such that skill levels as well as player characteristics can correspond to a real-life basketball player. Furthermore, such attributes of a player may be scaled by age, to extrapolate player characteristics at a corresponding age to a typical player of the sport (e.g., by increasing skill levels or height/weight of a junior player, or otherwise adjusting a skill level or weight of an older player in a recreational league such that the player's “avatar” is more competitive with the player avatars in the sports-based video game.

Referring generally to FIGS. 1-25, it is noted that various features of the present system may be made accessible to the users having different roles set forth above. For example, a league manager (e.g., a park/rec department employee or assigned individual) could be allowed to manage a league, upload images, moderate messages and/or posts, and manage communications regarding changes in venue, game reminders, rainouts, or other rescheduling issues. Similarly, a team captain or team manager may have similar abilities regarding sending a team reminders and indications of changes in venue or schedule. Players would similarly have abilities to access and edit personal information, such as a name, address, phone/email address, social profile, and messages. Additionally, statistical information and/or schedule information from the user interfaces can be posted to various social media sites, such as Facebook, Twitter, YouTube, and others.

Referring generally to the systems and methods of FIGS. 1-25, and referring to in particular computing systems embodying the methods and systems of the present disclosure, it is noted that various computing systems can be used to perform the processes disclosed herein. For example, embodiments of the disclosure may be practiced in various types of electrical circuits comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, aspects of the methods described herein can be practiced within a general purpose computer or in any other circuits or systems.

Embodiments of the present disclosure can be implemented as a computer process (method), a computing system, or as an article of manufacture, such as a computer program product or computer readable media. The term computer readable media as used herein may include computer storage media. Computer storage media may include volatile and nonvolatile, removable and non-removable media implemented in any method or technology for storage of information, such as computer readable instructions, data structures, or program modules. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing system 300, above. Computer storage media does not include a carrier wave or other propagated or modulated data signal. In some embodiments, the computer storage media includes at least some tangible features; in many embodiments, the computer storage media includes entirely non-transitory components.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

1. An integrated local sports league tracking and scoring system comprising:
a local sports management server comprising:
a league management component executable on the local sports management server, the league management component managing payment, scheduling, and team registration operations for one or more local sports leagues;
a player management component executable on the local sports management server, the player management component managing a plurality of players associated with the one or more local sports leagues;
a scoring component executable at least in part on the local sports management server, the scoring component configured to receive realtime data regarding scoring of a game occurring in the one or more local sports leagues, the scoring component including a user interface displayable on a remote system.

2. The integrated local sports league tracking and scoring system of claim 1, further comprising an application executable on a client computing system, the application including a scoring component including a scoring user interface receiving touch-screen input, the scoring user interface including a plurality of active touch areas associated with each user and type of scoring associated with a corresponding sport for which scoring is performed.

3. The integrated local sports league tracking and scoring system of claim 2, wherein the scoring user interface includes a plurality of pre-defined color commentary options.

4. The integrated local sports league tracking and scoring system of claim 1, wherein the application comprises a web application executable within a browser.

5. The integrated local sports league tracking and scoring system of claim 1, wherein the one or more local sports leagues are selected from among a group of leagues consisting of:
a basketball league;
a softball league;
a t-ball league;
a football league;
a hockey league;
a soccer league;
a volleyball league; and
a kickball league.

6. The integrated local sports league tracking and scoring system of claim 1, wherein users having a plurality of different user roles can access the league management component, the plurality of different user roles including a league manager, a team manager, a player, and a scorer.

7. The integrated local sports league tracking and scoring system of claim 1, wherein the one or more local sports leagues include a plurality of local sports leagues in different municipalities.

8. A method of tracking scoring in a local sports league application comprising:
presenting a user interface on a touchscreen mobile device, the user interface including a depiction a game played as part of a local sports league, the user interface including a plurality of selectable scoring regions, each of the plurality of selectable scoring regions corresponding to a different scoring event that may occur during the game;
receiving a touch input from a user, on the user interface at one of the plurality of selectable scoring regions;
upon receiving the touch input:
registering a scoring event associated with the scoring region at which the touch input is received; and
transmitting the scoring event to a local sports management server.

9. The method of claim 8, further comprising:
receiving from a second mobile device a score request occurring during the game; and
displaying at least near-realtime statistics aggregated during the game in a user interface on the second mobile device based on scoring events aggregated at the local sports management server and received from the touchscreen mobile device.

10. The method of claim 8, further comprising aggregating in a database at the local sports management server statistics regarding a plurality of leagues.

11. The method of claim 8, further comprising developing a user profile for each player included in the local sports league, the user profile being exportable to one or more third party systems.

12. The method of claim 11, wherein at least one of the one or more third party systems comprises a video game system including a video game associated with a sport played by the local sports league.

13. The method of claim 8, wherein the plurality of selectable scoring regions include selectable scoring regions that correspond to tracked scoring events occurring during the game.

14. The method of claim 8, further comprising generating a live box score at the local sports management server.

15. The method of claim 8, further comprising:
receiving a voice input uniquely associated with a scoring event that corresponds to a touch input at one or more of the selectable scoring regions, and upon receiving the voice input:
registering a scoring event; and
transmitting the scoring event to a local sports management server.
